(19) United States
(12) Patent Application Publication
(10) Pub. No.: US 2023/0259800 A1
(43) Pub. Date: Aug. 17, 2023

(54) GENERATIVE MODELS BASED ASSISTANT FOR DESIGN AND CREATIVITY

(71) Applicant: INTERNATIONAL BUSINESS MACHINES CORPORATION, Armonk, NY (US)

(72) Inventors: Oznur ALKAN, Clonsilla (IE); Rahul NAIR, Dublin (IE); Fearghal O'DONNCHA, Aran Islands (IE); Ambrish RAWAT, Dublin (IE)

(73) Assignee: INTERNATIONAL BUSINESS MACHINES CORPORATION, Armonk, NY (US)

(21) Appl. No.: 17/651,213

(22) Filed: Feb. 15, 2022

(51) Int. Cl. G06N 7/00; G06N 20/00

(52) U.S. Cl. CPC G06N 7/005; G06N 20/00

(57) ABSTRACT

Embodiments for providing enhanced generative models based assistance for design and creativity in a computing environment by a processor. A partially completed design of an object may be received. A set of recommendations may be generated for completing the partially completed design based on one or more generative models.

### BACKGROUND

The present invention relates in general to computing systems, and more particularly, to various embodiments for providing enhanced generative models based assistance for design and creativity in a computing environment using a computing processor.

### SUMMARY

According to an embodiment of the present invention, a method for providing enhanced generative models based assistance for design and creativity in a computing environment, by one or more processors, is depicted. A partially completed design of an object may be received. Aa set of recommendations may be generated for completing the partially completed design based on one or more generative models.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is an additional block diagram depicting an exemplary functional relationship between various aspects of the present invention.

FIG. 5 is additional block diagrams depicting operations of providing enhanced generative models based assistance for design and creativity in which aspects of the present invention may be realized.

FIG. 6 is a flowchart diagram depicting an additional exemplary method for providing enhanced generative models based assistance for design and creativity in a computing environment according to an embodiment of the present invention.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular data sets and use the generalizations to solve associated problems by, for example, classifying new data. Once a machine learns generalizations from (or is trained using) known properties from the input or training data, it can apply the generalizations to future data to predict unknown properties.

In machine learning and cognitive science, neural networks are a family of statistical learning models inspired by the biological neural networks of animals, and in particular the brain. Neural networks can be used to estimate or approximate systems and functions that depend on a large number of inputs and are generally unknown. Neural networks use a class of algorithms based on a concept of inter-connected “neurons.” In a typical neural network, neurons have a given activation function that operates on the inputs. By determining proper connection weights (a process also referred to as “training”), a neural network achieves efficient recognition of desired patterns, such as images and characters. Oftentimes, these neurons are grouped into “layers” in order to make connections between groups more obvious and to each computation of values. Training the neural network is a computationally intense process. For example, designing machine learning (ML) models, particularly neural networks for deep learning, is a trial-and-error process, and typically the machine learning model is a black box.

For example, the output of several creative and design ventures (e.g., interior designers, architects, graphic designers) may have “core design” elements from the designers or design studio and then use an artistic “boilerplate” that serves to complete the work. For example, an artistic “boilerplate” may include, by way of example only, furniture accessories, shrubbery/trees, engineering specs, iconography, etc. However, the use of the artistic “boilerplate” may in fact become time consuming particularly since the work follows directly from context of image (e.g., planning image for a landmark in a geographical location. Thus, a need exists for providing an artificial intelligent design assistant for creative design.

Accordingly, the present invention provides a novel solution by providing enhanced generative model-based assistance for design and creativity in a computing environment. In some implementations, a partially completed design of an object may be received. Aa set of recommendations may be generated for completing the partially completed design based on one or more generative models.

In other implementations, the present invention provides for capturing creative/design inputs and context from a canvas or digital platform. A Generative model, trained on a corpus of visual artifacts (e.g., via an ontology or knowledge domain) that analyses the canvas or digital platform. A recommendation of one or more visual elements are provided or suggested to be added as visual elements. The present invention provides a learning system to update the generative and recommender systems.

In some implementations, the present invention, using machine learning operations, receives (as input) a work-in-progress design and outputs a set of recommendations based on generative models to improve the work (e.g., the work-in-progress design) and provides one or more predictions from generative models add to the diversity that is valued in such creative processes. This makes the overall creative process more efficient as it reduces the effort required for manual completion.

To further illustrated, consider a use case when an event designer will create a fashion event that will take place in a street. The designer is obliged to provide the design portfolio that will demonstrate all the details of the event place. The designer draws the platform where the main event will take place. The designer starts drawing the surroundings of the platform. When the designer takes a pause in the middle of drawing an image (e.g., the designer pauses after drawing the trunk of the tree), the present invention may initiate an artificial intelligence/machine learning operation and provide one more drawings of the tree by providing different types of tree images with different coloring options.

Also, if the designer pauses after drawing a rectangle-like shape to draw a building, again, the present invention may initiate an artificial intelligence/machine learning operation and complete drawing the building by providing one or more different types of building images with different height, width, coloring, etc.

Also, in some implementations, the present invention may suggest, independent of the object the user is currently drawing or has just completed, one or more additional items to add to the object such as, for example, moving or standing people, cars, etc. In other implementations, the present invention may provide/suggest different options for the existing items in the drawing such as, for example, picking different colors, smoothing the edges, etc.

In other implementations, the designer is enabled to ask/query information from the present invention for options as recommendations to complete an image. The present invention may also automatically generate and suggest one or more recommendations or suggestions (via a graphical user interface “GUI”) at each detected pause of the designer so that the designer can select one or more of the more recommendations or suggestions.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

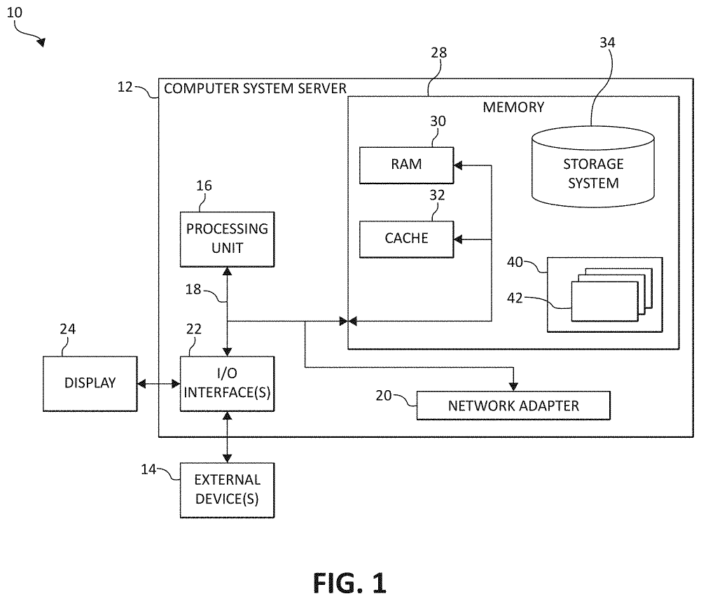

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 12.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

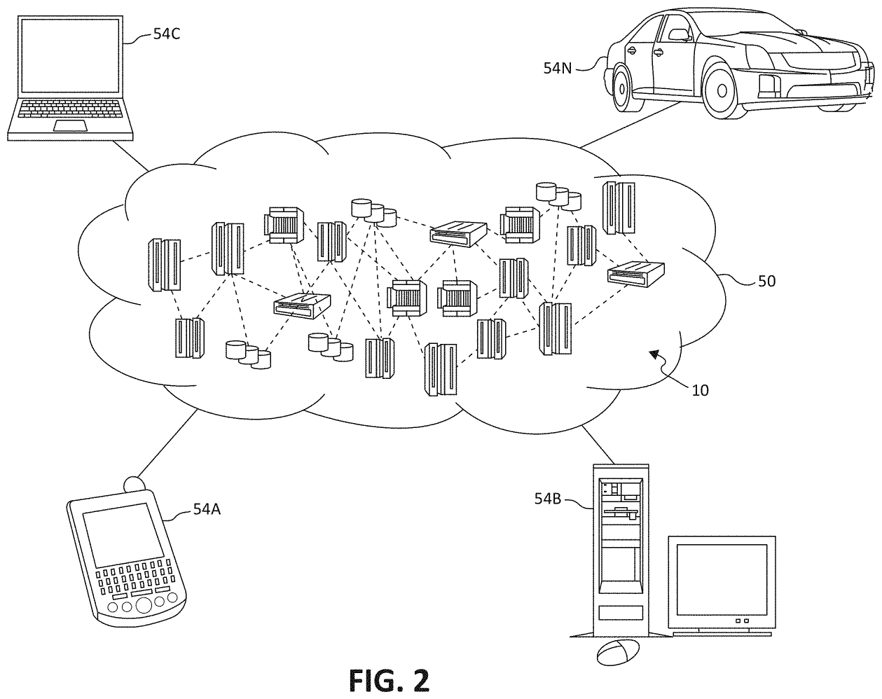

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

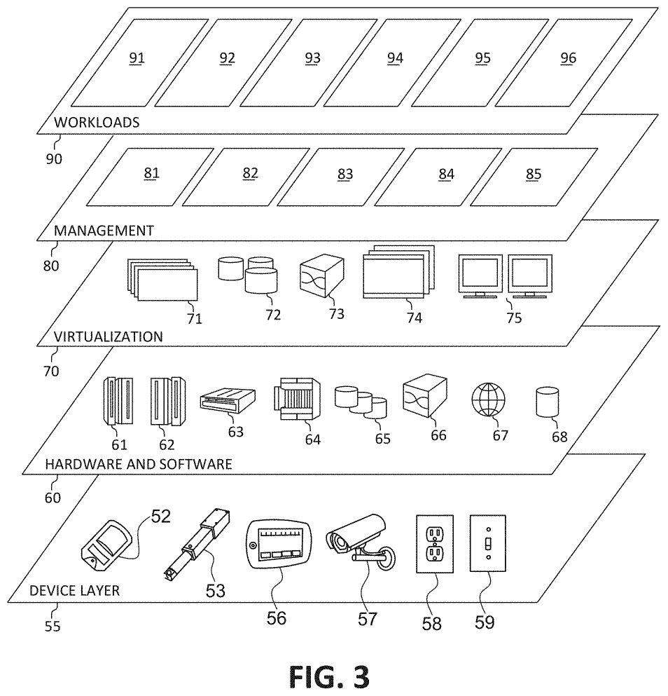

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing enhanced generative models based assistance for design and creativity. In addition, workloads and functions 96 for providing enhanced generative models based assistance for design and creativity may include such operations as data analytics, data analysis, and as will be further described, notification functionality. One of ordinary skill in the art will appreciate that the workloads and functions 96 for providing enhanced generative models based assistance for design and creativity may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As mentioned previously, the present invention provides for providing enhanced generative models based assistance for design and creativity in a computing environment. A partially completed design of an object may be received. Aa set of recommendations may be generated for completing the partially completed design based on one or more generative models.

In other implementations, the present invention may receive (as input) an intermediate stage of a design (e.g., a partial design of an object) from a design tool (e.g., an incomplete image. A set of users may provide inputs and the present invention produces as output a set of recommendations to improve the design by performing a set of operations via a digital assistant operation. The present invention orchestrates a design improvement workflow between context analyzer, a generative module, and a recommender. The present invention may, optionally, relay the successful improvements to the recommender. The present invention May 1) relay an incomplete image to a context analyzer, which supplies a context vector back to the system. The present invention sends the context vector, along with incomplete image, to a generative module (or component), which produces one or more improved images. The present invention fetches the improved images and feeds it to the recommender in order to retrieve a ranked list of improved images.

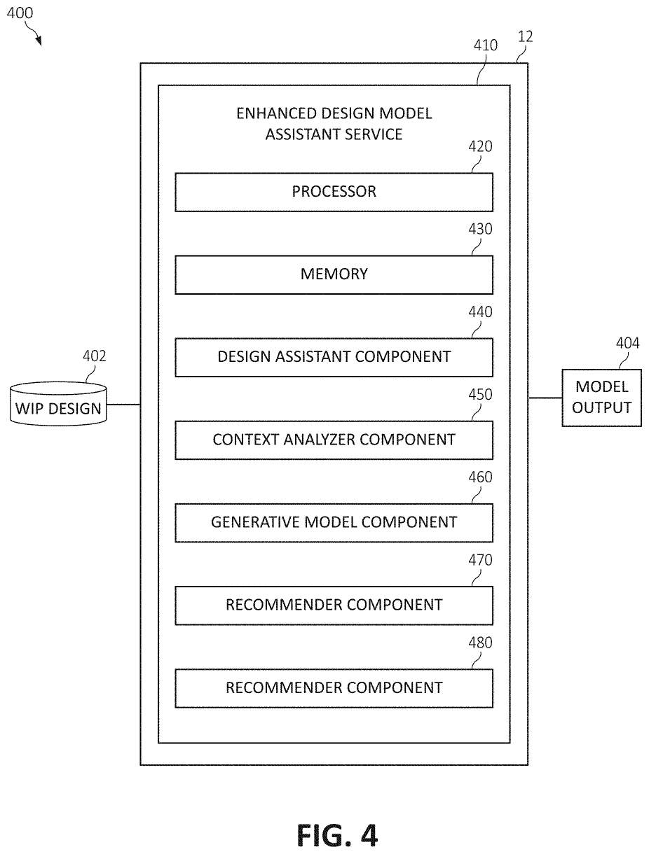

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. Repetitive description of like elements employed in other embodiments described herein is omitted for sake of brevity.

An enhanced design model assistant service 410 is shown, incorporating processing unit (“processor”) 420 to perform various computational, data processing and other functionality in accordance with various aspects of the present invention. The enhanced design model assistant service 410 may be provided by the computer system/server 12 of FIG. 1. The processing unit 420 may be in communication with memory 430. The enhanced design model assistant service 410 may include a design assistant component 440, a context analyzer component 450, a generative model component 460, a recommender component 470, and a machine learning component 480.

As one of ordinary skill in the art will appreciate, the depiction of the various functional units in enhanced design model assistant service 410 is for purposes of illustration, as the functional units may be located within the enhanced design model assistant service 410 or elsewhere within and/or between distributed computing components.

In general, by way of example only, the enhanced design model assistant service 410 may receive input data 402 such as, for example, a work-in-progress design. The input data 402 may include data or dataset, hyperparameters, feedback data, and/or machine learning model updates. That is, the enhanced design model assistant service 410 may receive input data 402, which may be: 1) data, 2) a model, 3) an object, and/or 4) an application.

The enhanced design model assistant service 410, using the design assistant component 440, the context analyzer component 450, the generative model component 460, a recommender component 470, and the machine learning component 480, may receive a partially completed design of an object; and generate a set of recommendations for completing the partially completed design based on one or more generative models.

The enhanced design model assistant service 410, using the design assistant component 440, the context analyzer component 450, the generative model component 460, a recommender component 470, and the machine learning component 480, may identify one or more sections of the partially completed design for applying the set of recommendations.

The enhanced design model assistant service 410, using the design assistant component 440, the context analyzer component 450, the generative model component 460, a recommender component 470, and the machine learning component 480, may generate one or more context vectors from one or more partial images of the partially completed design, wherein a context vector represents at least a portion of the object.

The enhanced design model assistant service 410, using the design assistant component 440, the context analyzer component 450, the generative model component 460, a recommender component 470, and the machine learning component 480, may generate a list of candidate suggestions for adding to the set of recommendations.

The enhanced design model assistant service 410, using the design assistant component 440, the context analyzer component 450, the generative model component 460, a recommender component 470, and the machine learning component 480, may rank each suggestion in a list of candidate suggestions adding to the set of recommendations.

The enhanced design model assistant service 410, using the design assistant component 440, the context analyzer component 450, the generative model component 460, a recommender component 470, and the machine learning component 480, may generate one or more enhanced images of the images from one or more incomplete images and a context vector using a generative model.

The enhanced design model assistant service 410, using the design assistant component 440, the context analyzer component 450, the generative model component 460, a recommender component 470, and the machine learning component 480, may learn the partially completed design of the object; train a machine learning model to learn and identify set of recommendations for completing the partially completed design based on one or more generative models; and automatically select or modify the set of recommendations for completing the partially completed design based on one or more generative models and collected feedback.

In one aspect, the various machine learning operations of the machine learning component 470, as described herein, may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

Additionally, the enhanced design model assistant service 410 (using one or more components therein) may perform one or more various types of calculations or computations. The calculation or computation operations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

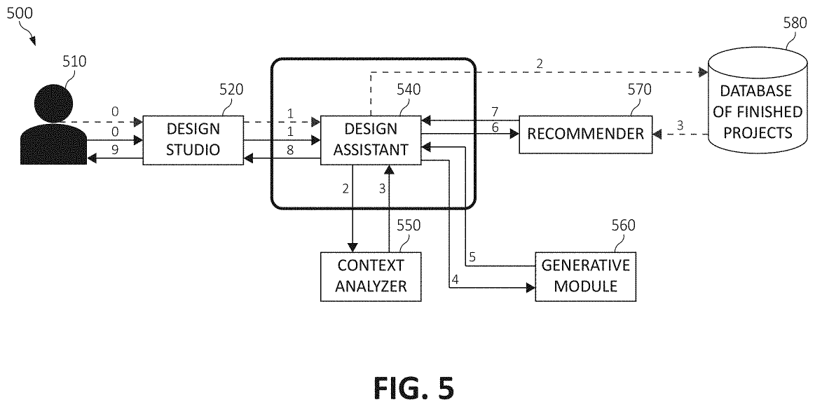

For further explanation, FIG. 5 is an additional block diagram depicting operations of providing enhanced generative models based assistance for design and creativity in which aspects of the present invention may be realized. In one aspect, one or more of the components, modules, services, applications, and/or functions described in FIGS. 1-4 may be used in FIG. 5. Repetitive description of like elements employed in other embodiments described herein is omitted for sake of brevity.

As a preliminary matter, as depicted in FIG. 5, a design studio 520, a design assistant 540, a context analyzer 550, a generative module 560, and a recommender are depicted with each being in communication with each other. In some implementations, the design studio 502 may be independent from the other components. In some implementations, the computer system/server 12 of FIG. 1 provides the design studio 520.

In some implementations, the computer system/server 12 of FIG. 1 provides and/or includes the design assistant 540, the context analyzer 550, the generative module 560, and the recommender 570, and database 580. In some implementations, the computer system/server 12 of FIG. 1.

In some implementations, the design assistant 540 orchestrates and automates the interaction between user inputs (e.g., Work-in-Progress design) on the design studio 520 and other components of the system (e.g., the computer system/server 12 of FIG. 1). The design assistant 540 may operate or work in an online manner such that it is triggered from the design studio 520 for any intermediate stage of the work-in-progress. This can be automated for whenever the user 510 remains idle for X amount of time (e.g., X number of seconds) during the creative process, where these parameters can be configured from the design studio 520 such as, the waiting time). The design assistant 540 can also be explicitly triggered by the user 510.

The flow that the design assistant 540 coordinates is depicted, by way of example only, in the example of FIG. 5 and the design assistant 540 enables the user-feedback for improved recommendations. The design assistant 540 may use one or more strategies to coordinate between the each of the components of FIG. 5 (e.g., the context analyzer 550, the generative module 560, and the recommender 570, and database 580). For example, the design assistant 540 can feed the output of the generative module 560 back to the context analyzer 550 to obtain new contexts. Similarly, the design assistant 540 may include basic filtering for suggested modifications before feeding it to the recommender 570.

The context analyzer 550 may takes a partial object (e.g., a partial image) as input and generates a context vector as output. A partial object (e.g., a partial image) can be, for example, an incomplete image (e.g., only a trunk of the tree), an incomplete canvas (e.g., an image of a street in which different objects can be added such as buildings, cars, people, etc.

A context vector includes a vector of pairs, where the object represents the objects to be added to the partial image, and location represents the coordinates/location that the corresponding object should be added to. The context vector may also represent a missing concept such as, for example, a shadow in which case the vector would look be a pair that includes a texture and location (e.g., <texture, location>.

The context analyzer 550 may include a combination of object recognition and set-difference operations that may be executed with respect to closest matching images in a representative dataset. More sophisticated algorithms such as, for example, a computer vision operation and a pattern recognition research can be utilized to achieve the functionality as required by the context analyzer 550. The operation of the context analyzer 550 may be used to implicitly learn masks for potentially missing objects.

The generative module 560 may receive/take, as input, a work-in-progress object (e.g., a partially drawn image) and the context vector from the context analyzer 550 such as, for example:

(partial_{image},{<obj₁,location₁>,<obj₂,location₂>, . . . ,<obj_{N},location_{N}>,}]).

The generative module 560 may generate, as output, a list of objects or images for each pair of the output of the context analyzer 550. The output of the context analyzer 550 may be in the form of triples, where suggestions include a list of candidate images. The generative module 560 may include one or more generative models.

The recommender 570 takes triples (e.g., <object, location, suggestions> triples) and ranks these suggestions based on historical data stored in the database 580 of finished projects. If no relevant project exists, the recommender 570 can return the input as it is. If relevant projects exists, it can enhance the suggestions with new additions and rank the final list based on previously provided ratings.

Any content-based recommender operation performed by the recommender 570 can be utilized to achieve the required functionality. The recommender 570 may be trained offline each time the database 580 of completed projects updated, which can be performed in a scheduled manner (e.g., every week, month, etc.), is analogous to triples in content-based setting. The recommender 570 more store both the partial image (e.g., a trunk of a tree) and suggestions (e.g., different tree images) and associated ratings that the user has provided upon receiving suggestions, and completion suggestions, where in this case the object (“obj”) stores an existing object or image (e.g., a tree that has been drawn) and suggestions store possible surrounding objects that are suggested. The database 580 of finished projects may store triples,

In operation, FIG. 5 depicts both a design flow (shown in FIG. 5 as solid lines) and a user feedback flow (shown in FIG. 5 as dashed lines). For the design flow, in step 0, a user 510 may design an illustration in the design studio 520, which may be a work-in-progress object (e.g., a partially drawn image) that triggers the design assistant 540. In step 1) the design assistant 540 fetches or receives the work-in-progress object (e.g., a partially drawn image) from the design studio 520. The design assistant 540 sends a communication message (e.g., calls) the context analyzer 550 with the work-in-progress object (e.g., a partially drawn image).

In step 3), the comparison module 560 analyzes the work-in-progress object (e.g., a partially drawn image), identifies a context of the work-in-progress object (e.g., a partially drawn image), identifies missing contextual data, and returns a context of what's missing (e.g., a suggestion pair that includes the concept and a location) that can be added to the work-in-progress object (e.g., a partially drawn image).

In step 4), the design assistant 540 relays the context information to the Generative module 560 for additional or possible completion suggestions.

In step 5), the generative module 560 responds to design assistant 540 with a possible list of completions/additions for the work-in-progress object (e.g., a partially drawn image).

In step 6), the design assistant 560 sends a communication message (e.g., calls) the recommender 570 with the work-in-progress object (e.g., a partially drawn image) and provides the response (e.g., the possible list of completions/additions for the work-in-progress object (e.g., a partially drawn image)) received from generative module 560.

In step 7), the recommender 570 enhances the suggestions (e.g., the possible list of completions/additions for the work-in-progress object) with possible suggestions and returns a ranked list of possible suggestions to the design assistant 540. In one aspect, a rating for the suggestions may be automatically provided (for each suggestions separately) based on a machine learning model, which may be based on a variety of parameters, contextual data (e.g., suggestion a sky includes stars based on identifying the absence of a sun or presence of a moon), or other ontological or knowledge data using data from the database of finished projects 580.

In step 8) the response collected from recommender 570 may be sent to design studio 520 In step 9), the design studio 520 may display options to the user 510.

Turning now to the user feedback flow, in step 0, a user 510 may provide feedback indicating approval or disapproval (e.g., like or does not like) and may provide another or new rating for the suggestions provided (for each suggestions separately). In step 1) the rating of the user 510 is sent to design assistant 540 by the design studio 520. In step 2), the design studio 520 feds the feedback to the database of finished projects 580.

In step 3), the database of finished projects 580 service feds the recommender 570 with new feedback data which triggers the recommender 570 to start a retraining process, which can be done once every X amount feedback is collected-based on the amount of the accumulated data, where X is a positive integer.

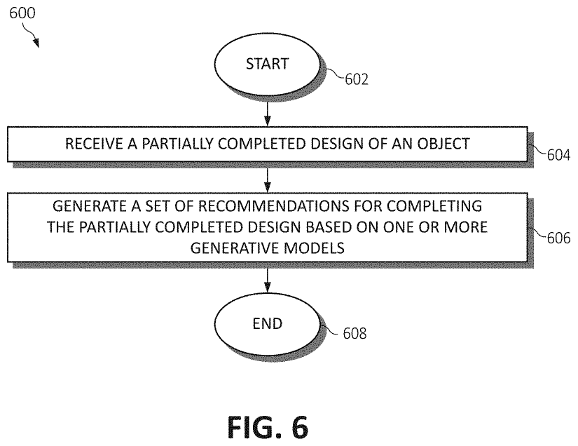

FIG. 6 is a flowchart diagram depicting an exemplary method for providing enhanced adversarial robustness of machine learning models using certification for federated learning in a computing environment. In one aspect, each of the devices, components, modules, operations, and/or functions described in FIGS. 1-5A-5B also may apply or perform one or more operations or actions of FIG. 6. The functionality 600 may be implemented as a method executed as instructions on a machine, where the instructions are included on at least one computer readable medium or one non-transitory machine-readable storage medium. The functionality 600 may start in block 602.

Input data may be received, where the input data is a set of machine learning model updates (e.g., federated learning updates from local nodes/clients), a dataset, and a set of hyperparameters, as in block 604. The dataset may be transformed into one or more abstract representations representing each one of a plurality of data points based on the set of hyperparameters, as in block 606. The one or more abstract representations may be sent or passed through a neural network, as in block 608. One or more certification parameters and one or more filtered machine learning model updates for a machine learning model may be generated (e.g., output of the neural network) by certifying each of plurality of data points using one or more abstract representations in a machine learning operation and filtering the plurality of machine learning model updates, as in block 610. The abstract representations represent each one of the plurality of data points. In one aspect, the functionality 600 may end, as in block 610.

FIG. 6 is a flowchart diagram depicting an exemplary method for providing enhanced generative models based assistance for design and creativity in a computing environment. In one aspect, each of the devices, components, modules, operations, and/or functions described in FIGS. 1-5 also may apply or perform one or more operations or actions of FIG. 6. The functionality 600 may be implemented as a method executed as instructions on a machine, where the instructions are included on at least one computer readable medium or one non-transitory machine-readable storage medium. The functionality 600 may start in block 602.

A partially completed design of an object may be received, as in block 604. Aa set of recommendations may be generated for completing the partially completed design based on one or more generative models, as in block 606. In one aspect, the functionality 600 may end, as in block 608.

In one aspect, in conjunction with and/or as part of at least one block of FIG. 6, the operations of method 600 may include each of the following. The operations of method 600 may identify one or more sections of the partially completed design for applying the set of recommendations. The operations of method 600 may generate one or more context vectors from one or more partial images of the partially completed design, wherein a context vector represents at least a portion of the object.

The operations of method 600 may generate a list of candidate suggestions for adding to the set of recommendations. The operations of method 600 may rank each suggestion in a list of candidate suggestions adding to the set of recommendations. The operations of method 600 may generate one or more enhanced images of the images from one or more incomplete images and a context vector using a generative model. The operations of method 600 may initialize a machine learning mechanism to: learn the partially completed design of the object; train a machine learning model to learn and identify set of recommendations for completing the partially completed design based on one or more generative models; and automatically select or modify the set of recommendations for completing the partially completed design based on one or more generative models and collected feedback.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, by a processor, for providing enhanced generative models based assistance in a computing environment, comprising:
receiving a partially completed design of an object; and
generating a set of recommendations for completing the partially completed design based on one or more generative models.

2. The method of claim 1, where further including identifying one or more sections of the partially completed design for applying the set of recommendations.

3. The method of claim 1, further including generating one or more context vectors from one or more partial images of the partially completed design, wherein a context vector represents at least a portion of the object.

4. The method of claim 1, further including generating a list of candidate suggestions for adding to the set of recommendations.

5. The method of claim 1, further including ranking each suggestion in a list of candidate suggestions adding to the set of recommendations.

6. The method of claim 1, further including generating one or more enhanced images of the images from one or more incomplete images and a context vector using a generative model.

7. The method of claim 1, further including initializing a machine learning mechanism to:
learn the partially completed design of the object;
train a machine learning model to learn and identify set of recommendations for completing the partially completed design based on one or more generative models; and
automatically select or modify the set of recommendations for completing the partially completed design based on one or more generative models and collected feedback.

8. A system for providing enhanced generative models based assistance in a computing environment, comprising:
one or more computers with executable instructions that when executed cause the system to:
receive a partially completed design of an object; and
generate a set of recommendations for completing the partially completed design based on one or more generative models.

9. The system of claim 8, wherein the executable instructions that when executed cause the system to identify one or more sections of the partially completed design for applying the set of recommendations.

10. The system of claim 8, wherein the executable instructions that when executed cause the system to generate one or more context vectors from one or more partial images of the partially completed design, wherein a context vector represents at least a portion of the object.

11. The system of claim 8, wherein the executable instructions that when executed cause the system to generate a list of candidate suggestions for adding to the set of recommendations.

12. The system of claim 8, wherein the executable instructions that when executed cause the system to rank each suggestion in a list of candidate suggestions adding to the set of recommendations.

13. The system of claim 8, wherein the executable instructions that when executed cause the system to generate one or more enhanced images of the images from one or more incomplete images and a context vector using a generative model.

14. The system of claim 8, wherein the executable instructions that when executed cause the system to initialize a machine learning mechanism to:
learn the partially completed design of the object;
train a machine learning model to learn and identify set of recommendations for completing the partially completed design based on one or more generative models; and
automatically select or modify the set of recommendations for completing the partially completed design based on one or more generative models and collected feedback.

15. A computer program product for providing enhanced generative models based assistance in a computing environment, the computer program product comprising:
one or more computer readable storage media, and program instructions collectively stored on the one or more computer readable storage media, the program instruction comprising:
program instructions to receive a partially completed design of an object; and
program instructions to generate a set of recommendations for completing the partially completed design based on one or more generative models.

16. The computer program product of claim 15, further including program instructions to identify one or more sections of the partially completed design for applying the set of recommendations.

17. The computer program product of claim 15, further including program instructions to generate one or more context vectors from one or more partial images of the partially completed design, wherein a context vector represents at least a portion of the object.

18. The computer program product of claim 15, further including program instructions to:
generate a list of candidate suggestions for adding to the set of recommendations; and
rank each suggestion in a list of candidate suggestions adding to the set of recommendations.

19. The computer program product of claim 15, further including program instructions to generate one or more enhanced images of the images from one or more incomplete images and a context vector using a generative model.

20. The computer program product of claim 15, further including program instructions to initialize a machine learning mechanism to:
learn the partially completed design of the object;
train a machine learning model to learn and identify set of recommendations for completing the partially completed design based on one or more generative models; and
automatically select or modify the set of recommendations for completing the partially completed design based on one or more generative models and collected feedback.
